(19) United States
(12) Patent Application Publication
(10) Pub. No.: US 2019/0042065 A1
(43) Pub. Date: Feb. 7, 2019

(54) PORTABLE TERMINAL AND CONTROL METHOD THEREOF

(71) Applicant: Samsung Electronics Co., Ltd., Suwon-si, Gyeonggi-do (KR)

(72) Inventor: Ho Yeon PARK, Seoul (KR)

(21) Appl. No.: 16/075,340

(22) PCT Filed: Apr. 27, 2016
(86) PCT No.: PCT/KR2016/004420

§ 371 Date: Aug. 3, 2018

(30) Foreign Application Priority Data
Feb. 5, 2016 (KR) 10-2016-0015308

(51) Int. Cl. G06F 3/0482; H04M 1/725; G06F 1/16

(52) U.S. Cl. CPC G06F 3/0482; G06F 1/163; H04M 1/725

(57) ABSTRACT

The present invention relates to a portable terminal including: a display configured to display an image of content; a user input configured to receive a user's input; and a controller configured to determine at least one menu relevant to the content and corresponding to a user among a plurality of menus, control the display to display the at least one determined menu, and perform an operation corresponding to a menu selected in response to the user's input among the at least one displayed menu.

Thus, a menu repetitively used by a user among the plurality of menus relevant to content running in the portable terminal is provided along with the content while the content is running.

### TECHNICAL FIELD

The present invention relates to a portable terminal and a control method thereof, and more particularly to a portable terminal and a control method thereof, in which only an optimized menu is provided among a plurality of menus available in relation to content being currently reproduced in the portable terminal, based on use information of content used in the portable terminal and use information of a menu used in relation to the content.

### BACKGROUND ART

With recent development of technology about a portable terminal such as a smart phone, various pieces of content have been available for a user through the portable terminal.

However, to use a menu related to content while using the content, a user has to terminate the content and find the menu.

For example, to do chatting about a live baseball game while watching the live baseball game through the portable terminal, a user has to terminate an application program of showing the baseball game, and then execute a chatting application program related to the baseball game.

In this case, a user has had to bear not only discontinuity in the baseball game but also inconvenience of finding the chatting application program related to the baseball game.

In particular, when the chatting about the baseball game is repetitively needed while watching the baseball game, a user cannot concentrate on both watching the baseball game and doing the chatting.

Accordingly, there is a need of offering an interface environment in which a menu repetitively used by a user among a plurality of menus related to content running on the portable terminal is provided along with the content while the content is running.

### DISCLOSURE

### Technical Problem

The object of the present invention is to provide a portable terminal and a control method thereof, in which a menu repetitively used by a user among a plurality of menus related to content running on the portable terminal is provided along with the content while the content is running.

### Technical Solution

The foregoing object of the present invention is achieved by providing a portable terminal including: a display configured to display an image of content; a user input configured to receive a user's input; and a controller configured to determine at least one menu relevant to the content and corresponding to a user among a plurality of menus, control the display to display the at least one determined menu, and perform an operation corresponding to a menu selected in response to the user's input among the at least one displayed menu.

Here, the controller may control the display to display the at least one determined menu while the image of the content is displayed on the display.

Here, the controller may determine a type of the content, and determine the at least one menu that can be provided in relation to the determined type of the content.

Here, the controller may determine the at least one menu, which corresponds to at least one of preference, use time and use place of the user with regard to the plurality of menus, among the plurality of menus.

Here, the controller may make at least one of the preference, use time and use place of the user with regard to the plurality of menus be weighted.

Here, the plurality of menus may include a menu that can be provided in relation to a sound of the content.

Further, the foregoing object of the present invention is achieved by providing a method of controlling a portable terminal including a display for displaying an image of content, the method including: determining at least one menu relevant to the content and corresponding to a user among a plurality of menus; displaying the at least one determined menu on the display; and performing an operation corresponding to a menu selected in response to a user's input among the at least one displayed menu.

Here, the displaying may include displaying the at least one determined menu while the image of the content is displayed on the display.

Here, the method may further include determining a type of the content, wherein the determining may include determining the at least one menu that can be provided in relation to the determined type of the content.

Here, the determining may include determining the at least one menu, which corresponds to at least one of preference, use time and use place of the user with regard to the plurality of menus, among the plurality of menus.

Here, the determining may include making at least one of the preference, use time and use place of the user with regard to the plurality of menus be weighted.

Here, the plurality of menus may include a menu that can be provided in relation to a sound of the content.

Further, the foregoing object of the present invention is achieved by providing a recording medium, in which a computer readable program is stored including a code for performing a method of a portable terminal, which includes a display for displaying an image of content, as a computer readable code, wherein the portable terminal operates by: determining at least one menu relevant to the content and corresponding to a user among a plurality of menus; displaying the at least one determined menu on the display; and performing an operation corresponding to a menu selected in response to a user's input among the at least one displayed menu.

### Advantageous Effects

According to the present invention, there are provided a portable terminal and a control method thereof, in which a menu repetitively used by a user among a plurality of menus related to content running on the portable terminal is provided along with the content while the content is running.

### DESCRIPTION OF DRAWINGS

FIG. 1 illustrates an example of a menu providing system according to one embodiment of the present invention.

FIG. 2 illustrates an example of a menu providing system according to one embodiment of the present invention.

FIG. 3 illustrates an example of an optimized menu offering process according to one embodiment of the present invention.

FIG. 4 illustrates an example of providing an optimized menu in a portable terminal according to one embodiment of the present invention.

FIG. 5 illustrates an example of providing an optimized menu in a portable terminal according to one embodiment of the present invention.

FIG. 6 is a block diagram of a portable terminal according to one embodiment of the present invention.

FIG. 7 illustrates an example of a customized model generation process according to one embodiment of the present invention.

FIG. 8 illustrates an example of a customized model generated according to one embodiment of the present invention.

FIG. 9 is a flowchart of determining an optimized menu in a portable terminal according to one embodiment of the present invention.

FIG. 10 illustrates a wearable terminal according to one embodiment of the present invention.

### BEST MODE

Hereinafter, the present invention will be described in detail with reference to the accompanying drawings. In embodiments set forth herein, only elements directly related to the idea of the present invention will be described, and descriptions about the other elements will be omitted. However, it will be understood that the omitted elements are not unnecessary when an apparatus or system to which the idea of the present invention is applied is materialized.

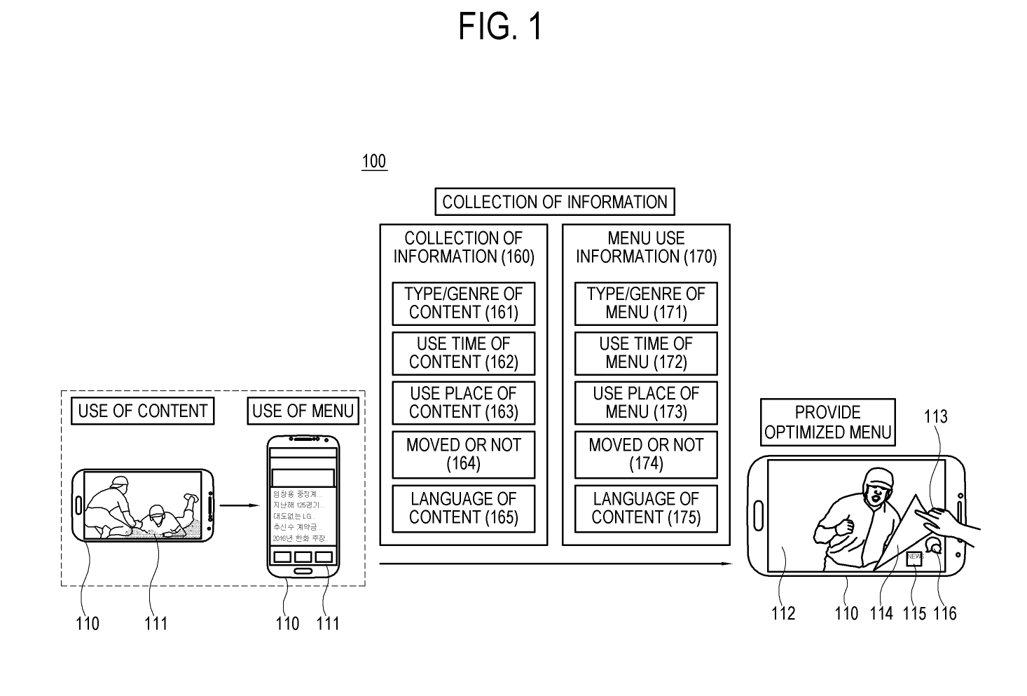

FIG. 1 illustrates an example of a menu providing system according to one embodiment of the present invention.

Referring to FIG. 1, a portable terminal 110 according to this embodiment may be materialized by a personal digital assistant (PDA) phone, a smart phone, or the like smart device, and executes application programs for performing various functions in itself.

The application programs to be run on the portable terminal 110 may include an application program for reproducing content such as music, a picture, a moving picture, etc.; an application program for making a call or sending a message (for a short message service (SMS)); an application program for chatting with others parties; an application program for executing a game; an application program for changing settings of the potable terminal 110; etc.

The portable terminal 110 may display menus involving icons corresponding to various application programs as a user interface (UI) on a display 111. The portable terminal 110 may execute an application program corresponding to a menu selected in response to a user's input through the display 111 among the plurality of menus corresponding to the application programs. For example, when a user selects an icon of an application program for displaying an image through the display 111, the portable terminal 110 executes the application program corresponding to the selected icon, thereby displaying the image of the content on the display 111.

Here, the portable terminal 110 may determine a menu repetitively used by a user among the plurality of menus related to the content displayed on the display 111, and display the determined menu on the display 111 in response to a user's request.

Below, it will be described in detail that a menu related to content being reproduced by the portable terminal 110 is determined based on content use information 160 and menu use information 170.

The portable terminal 110 may collect the content use information 160. The content use information 160 may include a type and genre 161 of content used in the portable terminal 110, use time 162 of the content, a use place 163 of the content, whether or not 164 the portable terminal 110 is moved while the content is used, a language 165 of the content, etc.

Here, the type of content may refer to a characteristic of content, which can be classified into music, a picture, a moving picture, etc. and the genre of content may refer to a characteristic of content, which can be classified into sports, drama, movie, etc. However, the classification of the type and genre is not limited to the foregoing. For example, the type of content may be classified in accordance with the content is a recorded broadcast or a live broadcast.

The portable terminal 110 may collect the menu use information 170 that is information about a menu related to content. Here, the menu related to the content may refer to a menu used in relation to the type, genre, use time, use place, etc. of the content running on the portable terminal 110.

For example, when a user executes a baseball-game chatting application program while watching a baseball game moving picture, the running baseball-game chatting application program may become a menu related in terms of the genre, use time, and use place of the baseball-game moving picture. However, such a menu is not limited to the application program, and may include various functions to be run on the portable terminal 110.

Thus, the menu use information 170 collected in the portable terminal 110 may include a type and genre 171 of a menu, use time 172 of the menu, a use place 173 of the menu, whether or not 174 the portable terminal 110 is moved while the menu is used, a language 175 of the menu, etc.

For example, it will be assumed that a user of the portable terminal 110 is watching a baseball-game image while going to work from home between 6 and 8 AM, and s/he terminates a baseball-game image and searches baseball-game news. Further, it will be also assumed that a user repetitively performs watching the baseball-game image and searching the baseball-game news at a stated time and place. The portable terminal 110 may collect information about the type and genre, use time, use place, and movement of the baseball-game image being viewed by a user. That is, the portable terminal 110 may collect the use information about the baseball-game image viewed by a user in the form of ‘moving picture/baseball game/6˜8 AM/going to work from home/being moved’.

Further, the portable terminal 110 may collect the use information about the baseball-game news, used after terminating the baseball-game image, as the menu use information 170. The use information about the baseball-game news may include the genre, use time, use place, and movement of the baseball-game news, and the portable terminal 110 may collect the use information in the form of ‘baseball-game news/6˜8 AM/going to work from home/being moved’.

The portable terminal 110 may generate a customized model corresponding to a user, based on the collected content use information 160 and menu use information 170. That is, the customized model may mean a model generated by combining the content use information 160 used in the portable terminal 110 and the menu use information 170 used in relation to the content. Thus, the customized model may include information about a certain menu used corresponding to certain content.

Such a customized model may be generated in the form of ‘(a user A)(the type of the content/the genre of the content)/(the genre of the menu/the use time of the menu/the use place of the menu/movement while using the menu/preference of the menu)’ since it is used according to users. For example, the customized model may be generated in the form of ‘(a user A)(the moving picture/the baseball game)/(the baseball-game news/6˜8 AM/going to work from home/movement/0.6)’. However, the content use information 160, the menu use information 170, and the customized model are not limited to the foregoing forms, and may be collected or generated in various forms.

Here, the preference of the menu may be determined based on a frequency of using the menu. That is, the customized model is generated based on how repetitively a user uses content and menu. The more repetitively a user uses a certain menu of certain content, the higher the preference for the certain menu is in the customized model.

Since the content used in the portable terminal 110 has various characteristics and the menu used in relation to the content has various characteristics, a plurality of customized models may be generated for one user.

For example, the customized models for the same baseball-game image content may be generated according to the use time of the content such as hours of going to work from 7 to 8 AM, hours of lunch break from 12 to 1 PM, and hours of going home from 6 to 7 PM, or according to the use place of the content such as home, an office, and a private education institute.

Thus, the portable terminal 110 may generate a plurality of customized models corresponding to users based on the content use information 160 and the menu use information 170, and store the generated customized models in the storage.

In a case where the customized model is generated, when a user reproduces content 112 through the portable terminal 110, the portable terminal 110 may recognize reproducing content based on information of the reproducing content 112. Here, the reproducing content 112 may include various kinds of content, such as music, a moving picture, etc. However, it will be assumed in FIG. 1 that a moving picture 112 is displayed on the display 111.

The information about the reproducing content 112 [symbol] the information may include information about the type, genre, use time, use place, etc. of the content. As necessary, the portable terminal 110 may recognize the content based on a content fingerprint of the reproducing content. Here, the content fingerprint refers to a pattern of a unique sound of the content and a unique pattern of an image signal to be distinguished from other pieces of content, and may include the brightness (luminance), frequency (gradient), etc. of the content.

When the current reproducing content 112 is recognized, the portable terminal 110 may determine at least one menu corresponding to a user among a plurality of menus offered in relation to the recognized content. That is, the portable terminal 110 determines the customized model, which includes the content use information 160 corresponding to the content 112 recognized among the plurality of customized models generated according to the content, and provides a menu related to the recognized content 112 based on the menu use information 170 included in the determined customized model.

For example, it will be assumed that the baseball-game image 112 is reproduced while a user A goes to work from home between 6 and 8 AM after generating the customized model. The portable terminal 110 recognizes the baseball-game image 112 based on the information and the content fingerprint of the baseball-game image 112 being reproduced, and determines the customized model including information corresponding to at least one among the type, genre, use time, use place and movement of the recognized image 112.

That is, the portable terminal 110 determines the customized model of ‘(a user A)(moving picture/baseball game)/(baseball-game news/6˜8 AM/going to work from home/being moved/0.6)’, in which the type and genre of the content is the ‘moving picture/baseball game’, among the plurality of customized models since the type and genre of the baseball-game image 112 being reproduced are ‘moving picture/baseball game.’

The determined customized model refers to a model of a baseball-game image, which involves information that a user frequently searches the baseball-game news while watching the baseball-game image at corresponding time and place.

Thus, the portable terminal 110 may configure an optimized menu 115 with a ‘baseball-game news’ menu that is a menu optimized to the baseball-game image 112 being reproduced based on the customized model.

Here, when a plurality of menus are included in the determined customized model or when a plurality of customized models are determined, a plurality of menus may be configured as the optimized menu 115.

The portable terminal 110 may receive a request for the optimized menu from a user. The portable terminal 110 may display the optimized menu configured corresponding to a user's request on the display 111.

In particular, the portable terminal 110 according to this embodiment may receive a user's request for the optimized menu while the content 112 is being reproduced, and provide the optimized menu in response to the request while the content 112 is reproduced.

That is, the portable terminal 110 may configure a background image to include the optimized menu 115, and display the optimized menu 115 in a certain area of the content 112 in response to a user's request for the optimized menu, thereby displaying the optimized menu 115 along with the content 112.

Here, the user's request for the optimized menu may be made by an operation 113 of dragging or triggering a left lower end of the display 111.

Further, the portable terminal 110 may display a partial area 114 of an image displayed on the display 111 in response to a user's request as if a page of a book is turned, and display optimized menus 115 and 116 on the background image in which the partial area 114 of the turned image is positioned.

Thus, the portable terminal 110 according to this embodiment may provide an optimized menu corresponding to a user among a plurality of menus that can be provided in relation to content being currently reproduced, through the customized model generated based on content and the user's pattern of using a menu related to the content. Thus, a user can quickly use the menu without any cumbersome process for finding the menu related to the content being reproduced.

Furthermore, the portable terminal 110 is convenient for a user to use the menus without terminating the content since the menus related to the content are displayed while the content is being reproduced.

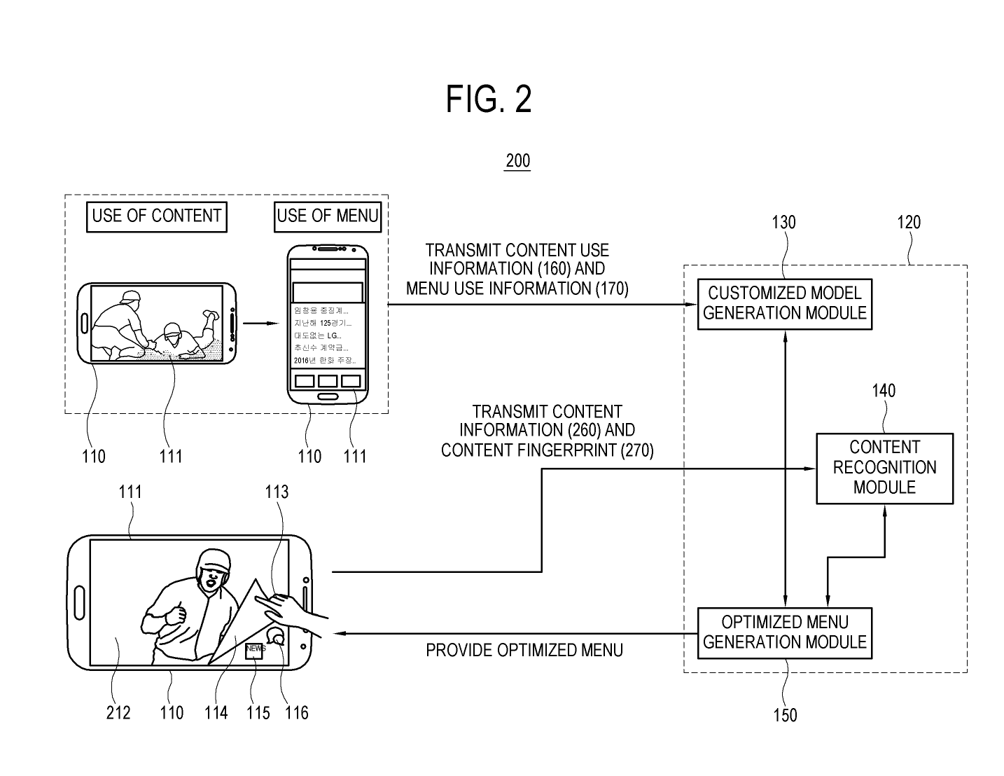

FIG. 2 illustrates an example of a menu providing system according to one embodiment of the present invention.

Referring to FIG. 2, the menu providing system 200 according to this embodiment may include a portable terminal 110, and a server 120 capable of exchanging data with the portable terminal 110 through a wired/wireless network. The portable terminal 110 of FIG. 2 may be equivalent to the portable terminal 110 of FIG. 1, and repetitive descriptions thereof will be avoided.

That is, FIG. 1 illustrates that the portable terminal 110 generates the customized model and configures the optimized menu corresponding to a user based on the generated customized model. On the other hand, in the menu providing system 200 according to this embodiment, the server 120 generates the customized model and configures an optimized menu corresponding to a user of the portable terminal 110.

Below, the menu providing system 200 according to this embodiment will be described in detail.

The portable terminal 110 according to this embodiment may collect at least one of the content use information 160 used in the portable terminal 110 and the menu use information 170 used in relation to the content, and transmit the collected information 160 and 170 to the server 120.

A customized model generation module 130 of the server 120 may generate a customized model corresponding to a user based on the information 160 and 170 collected by the portable terminal 110.

The server 120 may previously obtain information about a user who uses the portable terminal 110 and information about the portable terminal 110, and generate a customized model corresponding to the user of the portable terminal 110.

The customized model generation module 130 may generate the customized model according to users of the portable terminal 110, and may generate a plurality of customized models in accordance with the type, genre, use time, use place, use language, etc. of the content, and the type, kind, use time, use place, preference, etc. of the menu used in relation to the content even in a case of one user. The customized model generation module 130 may store the generated customized model.

In a case of generating the customized model, when new content 212 is reproduced in the portable terminal 110, the portable terminal 110 collects information 260 and content fingerprint 270 about content 212 being reproduced, and transmits them to a content recognition module 140 of the server 120. Here, the content information 260 to be transmitted may include information about the type, genre, use time, use, etc. of the content being reproduced.

The content recognition module 140 may recognize the content being reproduced in the portable terminal 110 based on the received content information 260 and content fingerprint 270. The content recognition module 140 transmits a result of recognizing the reproducing content to the portable terminal 110.

When it is determined that the content recognition module 140 recognizes the reproducing content, the portable terminal 110 may make a request for the optimized menu related to the reproducing content to the optimized menu generation module 150. Here, the optimized menu may refer to at least one menu corresponding to a user of the portable terminal 110 among the plurality of menus that can be provided in relation to the reproducing content. When making the request for the optimized menu, the portable terminal 110 may transmit a user's identification (ID) for authenticating the user to the optimized menu generation module 150.

The optimized menu generation module 150 of the server 120 determines the content being reproduced in the portable terminal 110 based on the received content information 260, and determines whether a user is authenticated based on the received user ID. The optimized menu generation module 150 may make a request for the customized model corresponding to the determined content and the authenticated user to the customized model generation module 130. The optimized menu generation module 150 may configure an optimized menu including at least one menu corresponding to the authenticated use, among the plurality of menus that can be provided in relation to the content determined based on the customized model received from the customized model generation module 130.

The optimized menu generation module 150 may transmit the configured optimized menu to the portable terminal 110, and the portable terminal 110 may configure a background image including the received optimized menu.

The portable terminal 110 may display the background image including the optimized menus 115 and 116 on a partial area of the content displayed on the display 111, in response to a user's request for the optimized menu.

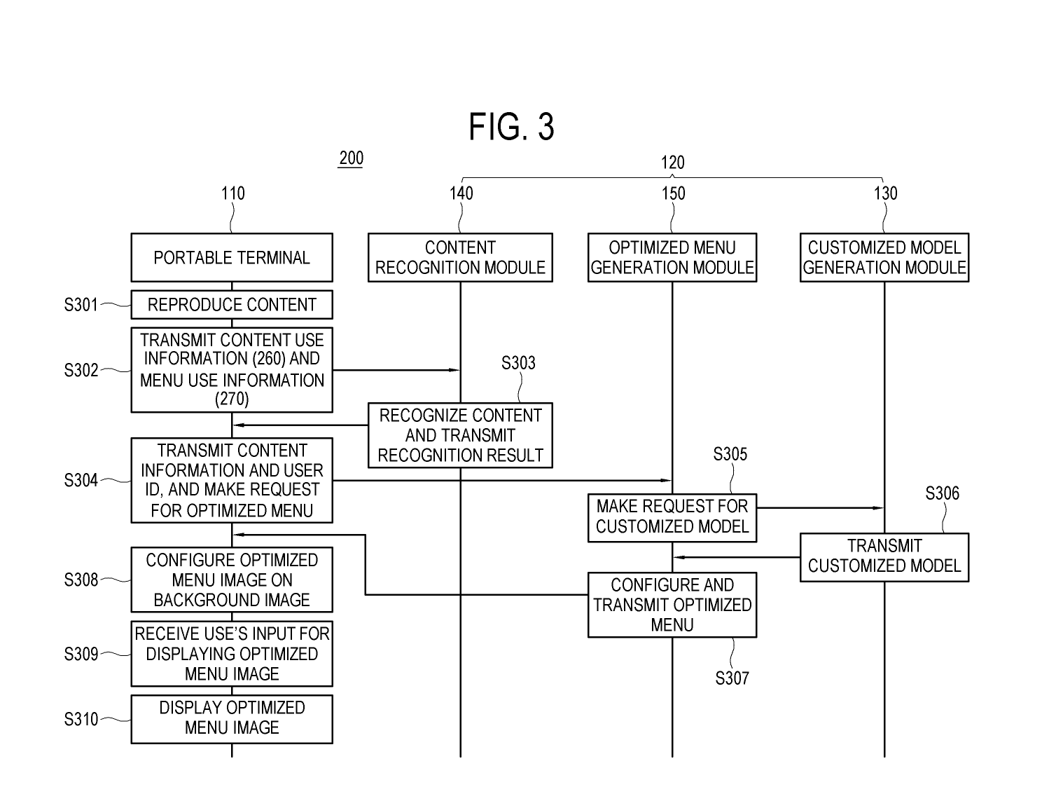

FIG. 3 illustrates an example of an optimized menu offering process according to one embodiment of the present invention.

Referring to FIG. 3, the menu providing system 200 according to this embodiment may include the portable terminal 110 and the server 120, and the server 120 may include the customized model generation module 130; the content recognition module 140; and the optimized menu generation module 150. However, the portable terminal 110 and the server 120 according to this embodiment are respectively equivalent to the portable terminal of FIG. 1 and the server 120 of FIG. 2, and repetitive descriptions thereof will be avoided as necessary.

According to this embodiment, the portable terminal 110 may reproduce content (S301), and collect and transmit information about the content being reproduced to the content recognition module 140 (S302). As necessary, the portable terminal 110 may transmit a fingerprint 270 of content being reproduced to the content recognition module 140.

The content recognition module 140 may recognize the content based on the information 260 of the content being currently reproduced and the content fingerprint 270, and transmit a recognition result to the portable terminal 110 (S303).

When it is determined that the content recognition module 140 recognizes the content being currently reproduced, the portable terminal 110 may make a request for an optimized menu to the optimized menu generation module 150 (S304). As necessary, the portable terminal 110 may transit the content information 260 and user ID to the optimized menu generation module 150.

The optimized menu generation module 150 may determine the content and user based on the received content information and user ID, and make a request for the customized model corresponding to the determined content and user to the customized model generation module 130 (S305). That is, according to this embodiment, it will be assumed that the customized model has already been generated based on the user of the portable terminal 110, and the content and menu used in the portable terminal 110.

The customized model generation module 130 may transmit the customized model corresponding to the determined content and user to the optimized menu generation module 150 (S306).

The optimized menu generation module 150 may generate the optimized menu including at least one menu corresponding to the determined user among the plurality of menus, which can be provided in relation to the content determined based on the received customized model, and transmit the generated optimized menu to the portable terminal 110 (S307).

The portable terminal 110 may configure an optimized menu image including the received optimized menu on the background image (S308).

Further, the portable terminal 110 may receive a user's input for displaying the optimized menu image while reproducing the content (S309), and display the optimized menu image in response to the user's input while reproducing the content (S310).

Here, the user's input for displaying the optimized menu image may include a dragging or triggering operation on the display 111.

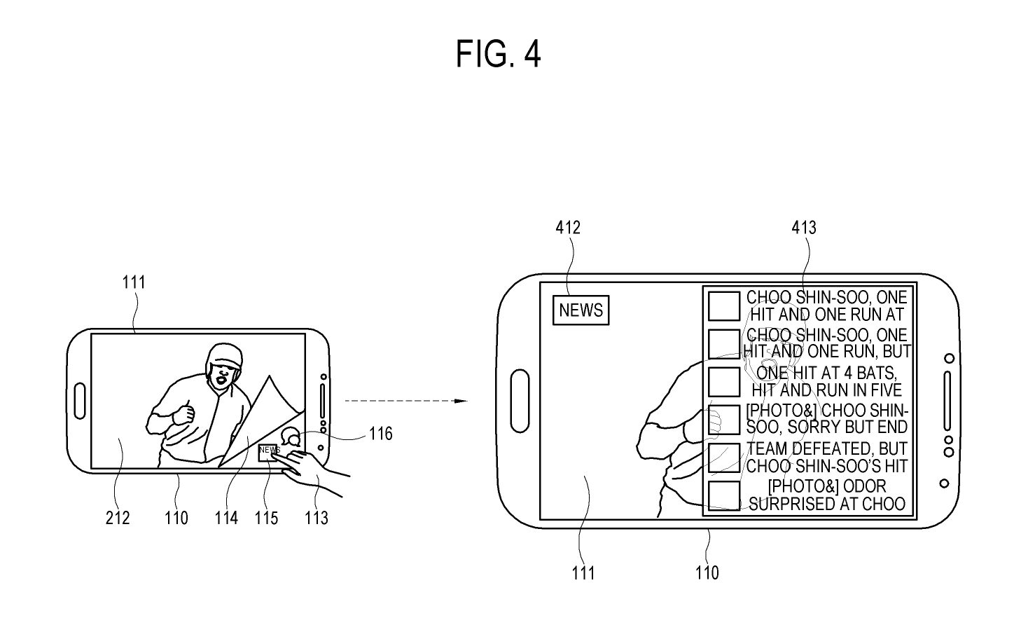

FIG. 4 illustrates an example of providing an optimized menu in a portable terminal according to one embodiment of the present invention.

The portable terminal 110 in this embodiment may correspond to the portable terminal 110 of FIG. 1, and therefore repetitive descriptions thereof will be avoided.

Referring to FIG. 4, the portable terminal 110 according to this embodiment may generate a customized model based on content use information and menu use information related to the content in terms of the type, genre, se time, use place, use language of the content.

After generating the customized model, the portable terminal 110 may receive a user's input of making a request for the optimized menu about a baseball-game image 212 being currently displayed, while displaying the image 212 on the display 111. Here, a user's input may include a dragging or triggering operation at one corner of the image 212 being reproduced.

The portable terminal 110 may display a background image which includes a plurality of optimized menus 115 and 116 on a partial area of the image 212 displayed in response to a user's request.

For example, the portable terminal 110 may display a ‘baseball-game news’ menu 115 and a ‘baseball-game chatting’ menu 116 as the optimized menus, and display content about baseball-game news 413 on the partial area of the baseball-game image 212 when the user selects the ‘baseball-game news’ menu 115. Here, content about the baseball-game image 212 and the baseball-game news 413 may be subjected to an alpha blending process and then displayed. Thus, the display 111 may display both the content of the baseball-game image 212 and the content of the baseball-game news 413. As necessary, the portable terminal 110 may display an icon 412 corresponding to the selected ‘baseball-game news’ menu on the partial area of the baseball-game image 212.

Thus, the portable terminal 110 according to this embodiment allows a user to search the baseball-game news 413 on the baseball-game image 212 in real time while viewing the baseball-game image 212 being reproduced.

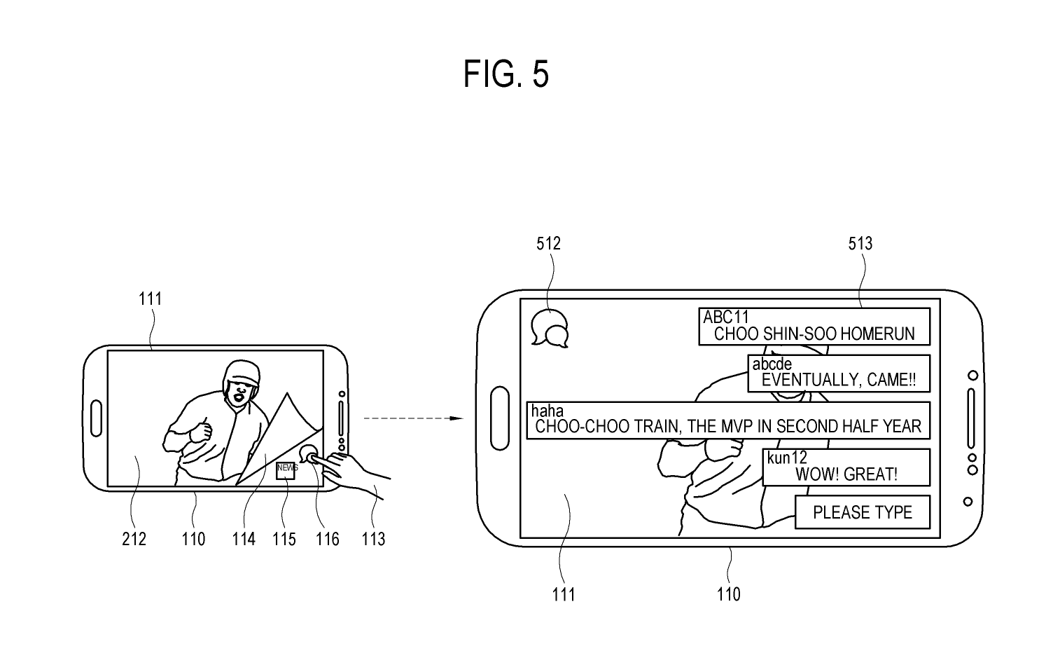

FIG. 5 illustrates an example of providing an optimized menu in a portable terminal according to one embodiment of the present invention.

The portable terminal 110 according to this embodiment is equivalent to the portable terminal 110 of FIG. 1, and repetitive descriptions thereof will be avoided.

Referring to FIG. 5, the portable terminal 110 according to this embodiment may be configured to display the baseball-game image 212 on the display 111, and receive a user's input of requesting an optimized menu to be displayed corresponding to the image 212 being currently displayed.

The portable terminal 110 may display a plurality of optimized menus 115 and 116 on a partial area of the image 212 in response to the user's input, while the image 212 is displayed on the display 111.

When the user selects the ‘baseball-game chatting’ menu 116 of the plurality of optimized menus 115 and 116, the portable terminal 110 may execute a baseball-game chatting function, and displays a chatting image 513 having a predetermined transparency on the display 111.

In particular, the chatting image 513 is displayed having a predetermined transparency on the partial area of the baseball-game image 212, and therefore a user can do chatting related to the baseball-game image 212 without terminating the baseball-game image 212. Here, the icon 512 corresponding to the ‘baseball-game chatting’ menu may be displayed on the partial area of the baseball-game image 212.

Like this, the portable terminal 110 according to this embodiment allows a user to do chatting relevant to the baseball game in real time watching the baseball-game image 212.

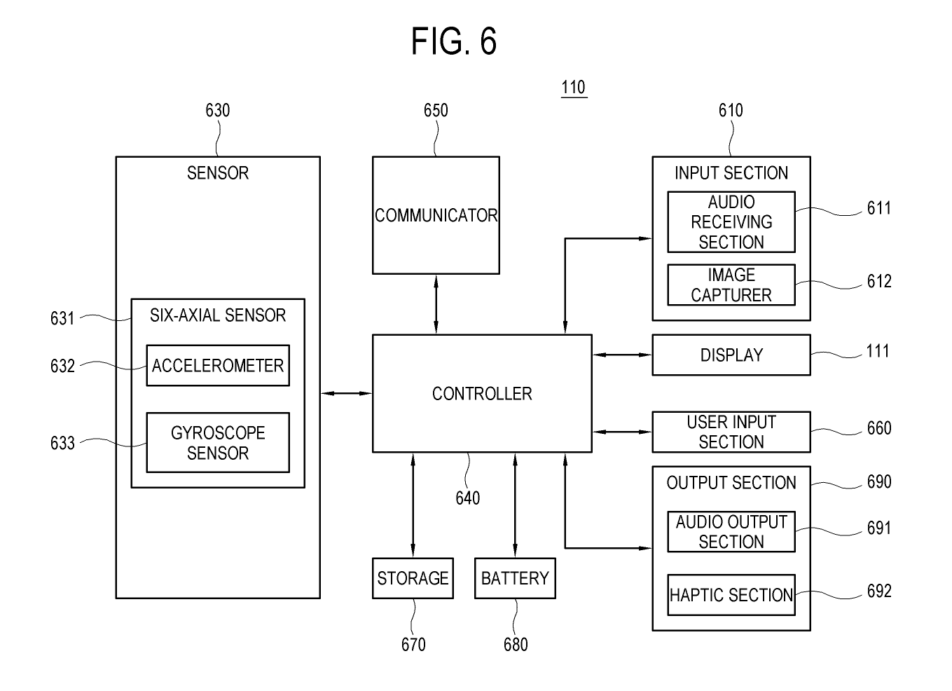

FIG. 6 is a block diagram of a portable terminal according to one embodiment of the present invention.

The portable terminal 110 according to this embodiment is equivalent to the portable terminal 110 of FIG. 1, and thus repetitive descriptions thereof will be avoided.

According to this embodiment, the portable terminal 110 may control of displaying a UI for interfacing with a user on the display 111, execute an application program in response to a user's input to the UI, and control various operations corresponding to the application program. For example, the portable terminal 110 displays a UI including an application program for reproducing content, and executes an application program for reproducing content in response to a user' input to the UI.

The portable terminal 110 may collect the content use information 160 used by executing the application program. The content use information 160 may include information about the types of content, such as music, a picture, a moving picture, etc. When the type of content is the moving picture, the content use information 160 may include information about the genre of content, such as sports, drama, movie, etc. When the type of content is the music, the content user information 160 may include information about the genre of content, such as a classic song, a pop song, a folk song, etc.

The portable terminal 110 may collect the content use information 160 and store it in the storage.

Below, the elements of the portable terminal 110 will be described in detail.

The portable terminal 110 includes an input section 610, a display 111, a sensor 630, and a controller 640. Further, the portable terminal 110 may additionally include at least one of a communicator 650, a user input section 660, a storage 670, a battery 680, an audio output section 691 and a haptic section 692.

The display 111 includes a display panel capable of displaying an image. Here, the display panel may be materialized by a liquid crystal display (LCD) panel, an organic light emitting diode (OLED) panel, an active matrix organic light emitting diode (AMOLED) panel, or a plasma display panel (PDP), etc.

The display 111 may display various images through the display panel. For example, the display 111 may display not only an image and a moving picture output by execution of the application program, but also a UI for controlling the portable terminal 110.

The sensor 630 includes at least one sensor for sensing a user's motion. For example, the sensor 630 may include at least one of a sensor 631 an accelerometer 632, and a gyroscope sensor 633 to sensing motions in six-axial directions. Here, the accelerometer 632 senses acceleration of gravity and movement in x, y, and z axes, thereby sensing whether the portable terminal 110 is moved or not. Further, the gyroscope sensor 633 senses angular velocity with respect to x, y, and z axes, and senses changed angle, thereby sensing a moving direction of the portable terminal 110. The sensor 630 senses a user's motion in the six-axial directions based on at least one sense results of the accelerometer 632 and the gyroscope sensor 633.

Further, the sensor 630 may further include a global positioning system (GPS) sensor for obtaining a user's location information.

The controller 640 may be materialized by a central processing unit (CPU), a microprocessor, etc. and generally controls operations of elements of the portable terminal 110.

Specifically, the controller 640 may collect the content use information 160 used in the portable terminal 110, and the menu use information 170 about the content, and generate the customized model based on the collected content use information 160 and menu use information 170.

When the customized model is generated, the controller 640 may extract the content information from the content being reproduced in the portable terminal 110, and determine the customized model corresponding to the extracted content information. In particular, the controller 640 makes the content information be weighted and determines the customized model in accordance with the weighted content information.

For example, the controller 640 may extract information about the type/genre/use time/use place/use language of the content from the content being reproduced, and make the type/genre of the content be weighted among the extracted pieces of information. The controller 640 may preferentially select and determine the customized model, which corresponds to the type/genre of the content rather than the use time/use place/use language of the content being reproduced, among the plurality of customized models.

Thus, the controller 640 may configure the optimized menu in accordance with the menu use information 170 included in the preferentially determined customized model.

Further, the controller 640 may display the configured optimized menu on the display 111 without terminating the reproducing content, when a user makes a request for the optimized menu related to the reproducing content while the content is reproduced.

Meanwhile, when the optimized menu is configured by the server 120, the controller 640 may transmit the collected content use information 160 and menu use information 170 to the server 120 via the communicator 650, and receive the optimized menu configured by the server 120. The controller 640 may control the display 111 to display the optimized menu when receiving a user's input of making a request for the optimized menu.

The communicator 650 may include a communication module for accessing a predetermined network by a wire or wirelessly. For example, the communicator 650 may include a module for Bluetooth, a wireless LAN (WLAN), wireless fidelity (Wi-Fi), 3G, long term evolution (LTE), wireless broadband (Wibro), world interoperability for microwave access (Wimax), code division multiple access (CDMA), wideband code division multiple access (WCDMA), etc. Further, the communicator 650 may include a communication module based on near field communication (NFC).

The user input section 660 may be materialized by a touch screen to which a command or information is input to a user's touch control; a jog wheel or the like jog method of rotating a key; etc. When the user input section 660 is materialized by the touch screen, the user input section 660 may have the function of the display 111.

The storage 670 may include at least one type of storage medium, such a flash memory type, a hard disk type, a multimedia card micro type, a card type memory (secure digital (SD) or XD memory, etc.), a random access memory (RAM), and a read only memory (ROM). The storage 670 may store various application programs, and a lot of content to be reproduced by the application program.

Further, the storage 670 may store a program for the process and control of the controller 640, the unique information of the portable terminal 110, user information including a user ID and a password, and the content use information 160 about the content being reproduced in the portable terminal 110.

The battery 680 supplies power to the elements of the portable terminal 110, and is detachably coupled to the portable terminal 110 to do charging or the like.

An audio receiving section 611 may be materialized by a microphone, receives an external audio signal and processes the received audio signal into electric audio data. The audio receiving section 611 may use various noise canceling algorithms for removing noise caused while receiving the external audio signals.

An image acquirer 612 captures an image, and processes the captured image to be displayed on the display 111.

The audio output section 691 outputs audio data received from the communicator 650 or stored in the storage 670. The audio output section 691 may include a loudspeaker, a buzzer, and the like.

The haptic section 692 generates various haptic effects a user can feel. When the haptic section 692 generates vibration as the haptic effect, the vibration may be changed in strength, pattern, etc. or different kinds of vibration may be output as synthesized or in sequence.

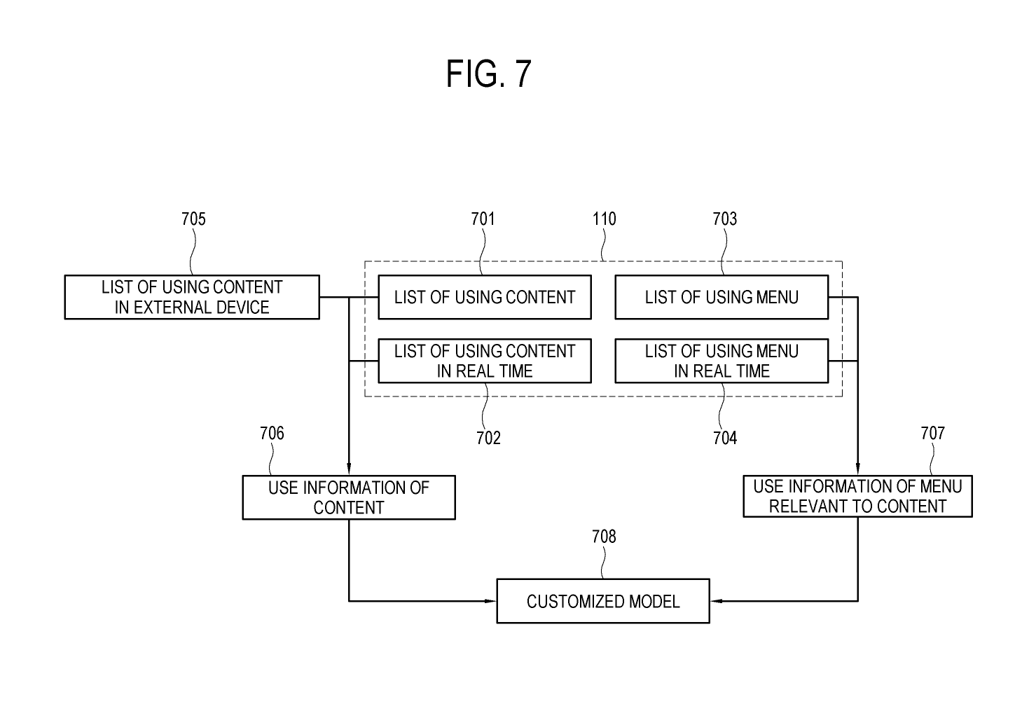

FIG. 7 illustrates an example of a customized model generation process according to one embodiment of the present invention.

According to this embodiment, the controller 640 is equivalent to the controller 640 of FIG. 6, and thus repetitive descriptions thereof will be avoided.

Referring to FIG. 7, the controller 640 according to this embodiment may collect content use information 706 from a use list 701 of content used by a user in the portable terminal 110, a real-time use list 702 of content being currently used, a use list 705 of content used in an external device such as a personal computer (PC), a web storage, etc. and the like. Here, the controller 640 may collect the content use information 706, based on meta data extracted from each piece of content and information about time and location sensed by the sensor 630 when each piece of content is used.

The content use information 706 collected by the controller 640 may include information about the ‘type/genre/use time/use place of the content/whether there is movement or not while using the content’.

Further, the controller 640 may collect menu use information 707 related to the content, based on a use list 703 of a menu used by a user in the portable terminal 110 and a real-time use list 704 of the menu being currently used.

The menu use information 707 collected by the controller 640 may include the ‘the type/genre/kind/use time/use place of the menu/whether there is movement or not while using the menu/the preference of the menu’.

The controller 640 may generate customized model 708 by matching the elements of the collected content use information 706 with the elements of the menu use information 707, respectively.

For example, when a user repetitively listens to classic music while going to work from home between 6 and 8 AM, the content use information 706 may be collected in the form of ‘music/classic/6 to 8 AM/going to work from home/moving’. Further, when a user repetitively does chatting about the classic music while listening to the classic music at the same time and place as above, the menu use information 707 may be collected in the form of ‘music/classic/chatting about classic music/6 to 8 AM/going to work from home/moving/preference of 0.1’.

When the customized model is given in the form of ‘(the type of the content/the genre of the content)/(the genre of the menu/the use time of the menu/the use place of the menu/whether there is movement or not while using the menu/the preference of the menu)’, the controller 640 may generate the customized model in the form of ‘(music/classic)/(chatting about classic music/6 to 8 AM/going to work from home/moving/preference of 0.1)’. However, the customized model is not limited to the foregoing format, and may be configured with a format different from the foregoing format as necessary.

The controller 640 may control the storage 670 to store the generated customized model. However, when the server 120 provides the optimized menu, the generated customized model may be transmitted to the server 120.

Below, a plurality of customized model generated for one user will be described in detail.

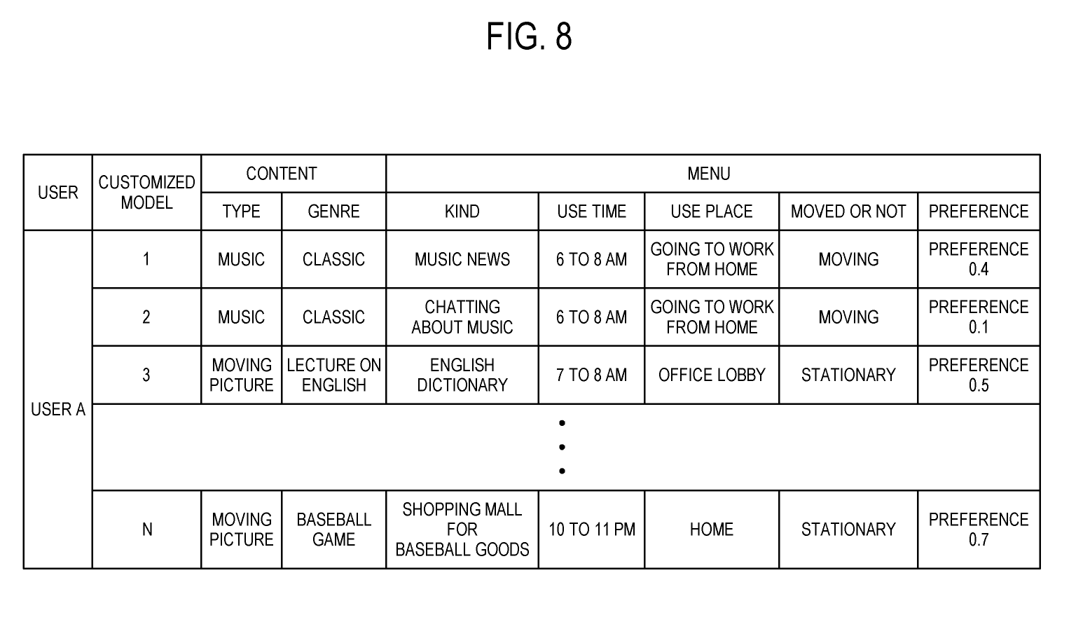

FIG. 8 illustrates an example of a customized model generated according to one embodiment of the present invention.

A controller 640 according to this embodiment may be equivalent to the controller 640 of FIG. 6, and thus repetitive descriptions thereof will be avoided.

According to this embodiment, the controller 640 may generate a customized model of a user A based on the content use information 706 of the user A, and information 707 about at least one menu used in relation to the content. Here, at least one menu used in relation to the content may refer to a menu used correlating with the type, genre, use time, use place and the like of the content.

For example, it will be assumed that a user A always listens to ‘classic music’ while going to work from home between 6 and 8 AM, and generally searches the latest music news through a ‘music news’ menu but occasionally do ‘chatting about music’. Further, it will be also assumed that a user A sometimes watches ‘lectures on English’ in an office lobby and uses a ‘English dictionary’ when s/he reaches the office early between 7 and 8 AM.

When such a pattern is repeated more than a predetermined number of times, the controller 640 may generate a customized model #1 and a customized model #2 for a user A, based on the use information 706 of the ‘classic music’ used by the user A and the use information 707 of a menu for the ‘music news’ and the ‘chatting about music’ used in relation to the ‘classic music’. Further, the controller 640 may generate a customized model #3 based on the use information 706 of the ‘lectures on English’ used by the user A and the use information 707 of a menu for the ‘English dictionary’ used in relation to the ‘lectures on English’.

Specifically, the customized model #1 and the customized model #2 may be respectively generated in the forms of ‘(music/classic)/(classic music news/6 to 8 AM/going to work from home/moving/preference of 0.4)’ and ‘(music/classic)/(chatting about classic music/6 to 8 AM/going to work from home/moving/preference of 0.1)’, and the customized model 3 may be generated in the form of ‘(moving picture/lectures on English)/(English dictionary/7 to 8 AM/office lobby/stationary/preference of 0.5)’.

When a user reproduces certain content with the plurality of customized models generated as described above, the controller 640 determines a customized model corresponding to the content based on information about the content being reproduced, and configure an optimized menu with menus included in the determined customized model.

For example, when a use plays classic music between 7 and 8 AM with his/her customized models #1, #2 and #3, the controller 640 may collect information about the type, genre, use time, and use place of the classic music being played. The controller 640 may determine the customized model #1 and the customized model #2 corresponding to the collected use information of the classic music, and configure the optimized menu with the menus of ‘music news’ and ‘chatting about music’ included in the respective customized models.

However, the customized model #3 is generated based on the menu use information used by the user A between 7 and 8 AM, but the type and genre of the content are different from those of the classic music being played. Therefore, the controller 640 may not configure the optimized menu with the menu of ‘English dictionary’ included in the customized model #3.

In this case, the controller 640 may determine the customized model based on a percentage of matching elements between the elements of information about the classic music being played and the elements of the customized model, and may determine the customized model by making the elements of the information about the classic music be differently weighted.

For example, when the ‘use time’ of the menu is weighted, the optimized menu may be configured with the ‘music news’ menu and the ‘chatting about music’ menu rather than the ‘English dictionary’ menu even though the user A is in the office lobby between 6 and 7 AM.

On the other hand, when the ‘use place’ of the menu is weighted, the optimized menu may be configured with the ‘English dictionary’ even while the user A is going to work from home between 7 and 8 AM.

Likewise, when the ‘preference’ of the menu is weighted, the optimized menu may be configured with the ‘English dictionary’ even though the user A is listening classic music between 7 and 8 AM.

Further, the elements of the customized model may be weighted with different ratios. For example, the ‘use time’: ‘use place’: ‘preference’ of the customized model may be weighted with a ratio of 2:3:5.

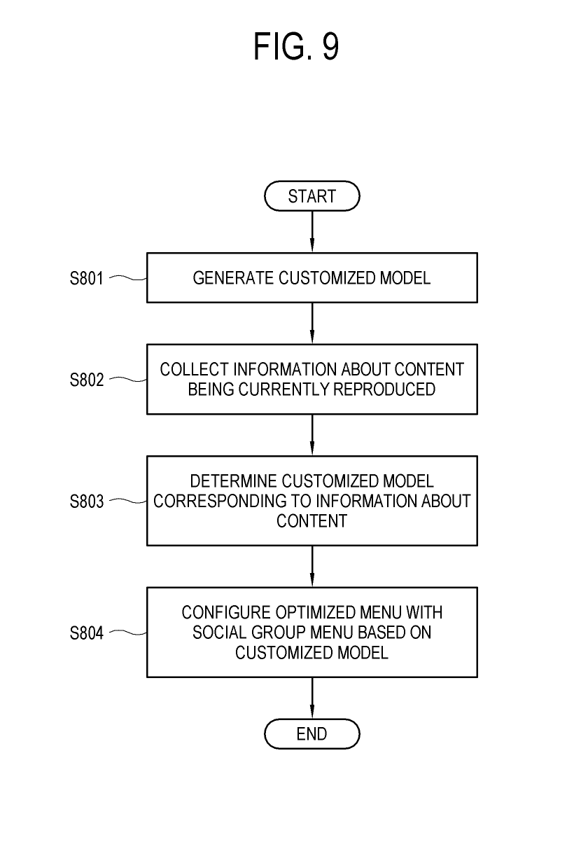

FIG. 9 is a flowchart of determining an optimized menu in a portable terminal according to one embodiment of the present invention.

The portable terminal 110 according to this embodiment is equivalent to the portable terminal 110 of FIG. 1, and thus repetitive descriptions thereof will be omitted.

Referring to FIG. 9, the portable terminal 110 according to this embodiment may generate a customized model according to users, based on the content use information 160 about content previously used in the portable terminal 110, and the menu use information 170 used in relation to the content (S901).

The portable terminal 110 may collect information about content from the content being currently reproduced (S902).

The portable terminal 110 may determine the customized model corresponding to the collected information about the content, and configure the optimized menu based on the determined customized model (S903).

In particular, when the optimized menu is a menu about a social group in which a plurality of users can do chatting in a virtual space, a social group menu corresponding to the determined customized model determined among the plurality of social group menus may be configured as the optimized menu (S904).

For example, in a case where a user of the portable terminal 110 does chatting about music and chatting about a baseball game in specific time and place, the portable terminal 110 may provide the optimized menu with the social group menu related to the baseball game instead of the social group menu related to the music when the baseball-game image is reproduced in the specific time and place.

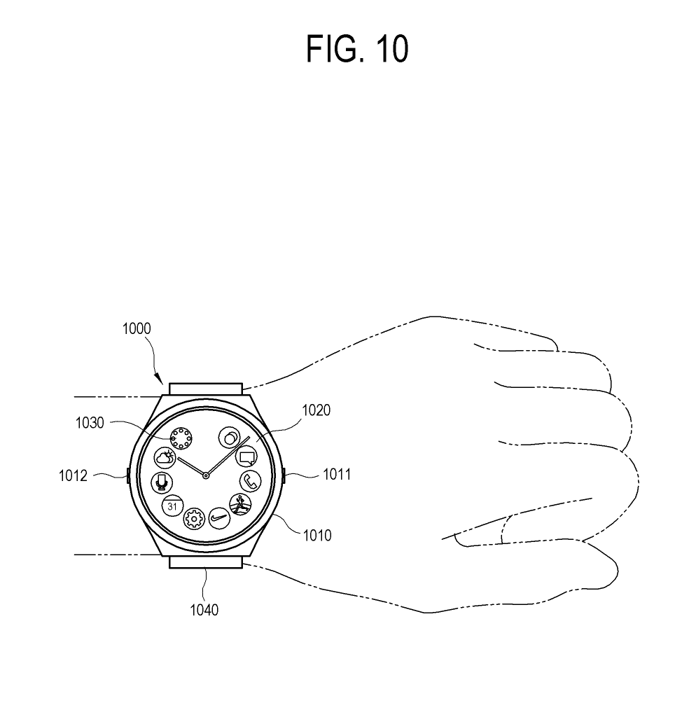

FIG. 10 illustrates a wearable terminal according to one embodiment of the present invention.

A wearable terminal 1000 according to this embodiment may include at least one among the elements of the portable terminal 110 shown in FIG. 6, and thus repetitive descriptions thereof will be avoided.

Thus, the wearable terminal 1000 according to this embodiment may include an input section 610 including an audio receiving section 611 or 1011 and an image acquirer 612, a display 111 or 1020, a sensor 630, and a controller 640. Further, the wearable terminal 1000 may further include at least one among a communicator 650, a user input section 660, a storage 670, a battery 680, an audio output section 691 or 1012, and a haptic section 692.

However, the wearable terminal 1000 may include a circular or quadrangular main body 1010, and the main body 1010 may include the audio receiving section 1011, the audio output section 1012, and the display 1020.

The display 1020 may display a plurality of icons 1030 corresponding application programs for performing different functions. That is, the plurality of icons 1030 corresponds to at least one application program to be run in the wearable terminal 1000 or a certain function of the wearable terminal 1000.

The wearable terminal 1000 may generate a customized model corresponding to a user based on the use information 160 about content used in the wearable terminal 1000, and the use information 170 about a menu used in relation to the used content.

In particular, the sensor 630 of the wearable terminal 1000 may further include a heartrate sensor for sensing a user's heartrate, and thus reflect information about the user's heartrate onto the customized model.

Thus, the wearable terminal 1000 may generate more subdivided customized models, and configure an optimized menu more suited for a user's tastes based on the subdivided customized model.

Although the present invention have been described in detail though preferred embodiments, the present invention is not limited to these embodiment but variously embodied within appended claims.

1. A portable terminal comprising:
a display configured to display an image of content;
a user input configured to receive a user's input; and
a controller configured to:
determine at least one menu, relevant to the content and corresponding to the user, among a plurality of menus,
control the display to display the at least one determined menu, and
perform an operation corresponding to a menu selected in response to the user's input among the at least one displayed menu.

2. The portable terminal according to claim 1, wherein the controller is further configured to control the display to display the at least one determined menu while the image of the content is displayed on the display.

3. The portable terminal according to claim 1, wherein the controller is further configured to:
determine a type of the content, and
determine the at least one menu that can be provided in relation to the determined type of the content.

4. The portable terminal according to claim 1, wherein the controller is further configured to determine the at least one menu, which corresponds to at least one of preference, use time, or use place of the user with regard to the plurality of menus, among the plurality of menus.

5. The portable terminal according to claim 4, wherein the controller is further configured to make at least one of the preference, use time, or use place of the user with regard to the plurality of menus, be weighted.

6. The portable terminal according to claim 1, wherein the plurality of menus comprises a menu that can be provided in relation to a sound of the content.

7. A method of controlling a portable terminal comprising a display for displaying an image of content, the method comprising:
determining at least one menu, relevant to the content and corresponding to a user, among a plurality of menus;
displaying the at least one determined menu on the display; and
performing an operation corresponding to a menu, selected in response to a user's input, among the at least one displayed menu.

8. The method according to claim 7, wherein the displaying comprises displaying the at least one determined menu while the image of the content is displayed on the display.

9. The method according to claim 7, further comprising determining a type of the content,
wherein the determining comprises determining the at least one menu that can be provided in relation to the determined type of the content.

10. The method according to claim 7, wherein the determining comprises determining the at least one menu, which corresponds to at least one of preference, use time, or use place of the user with regard to the plurality of menus, among the plurality of menus.

11. The method according to claim 10, wherein the determining comprises making at least one of the preference, use time, or use place of the user with regard to the plurality of menus, be weighted.

12. The method according to claim 7, wherein the plurality of menus comprises a menu that can be provided in relation to a sound of the content.

13. A recording medium, in which a computer readable program is stored comprising a code for performing a method of a portable terminal, which comprises a display for displaying an image of content, as a computer readable code, wherein the portable terminal operates by:
determining at least one menu, relevant to the content and corresponding to a user, among a plurality of menus;
displaying the at least one determined menu on the display; and
performing an operation corresponding to a menu, selected in response to a user's input, among the at least one displayed menu.
